(19) United States
(12) Patent Application Publication
(10) Pub. No.: US 2006/0078673 A1
(43) Pub. Date: Apr. 13, 2006

(54) Method for printing using invisible inks

(76) Inventor: Jacqueline Ripstein, Aventura, FL (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/220,342

(22) Filed: Sep. 6, 2005

Related U.S. Application Data
(60) Provisional application No. 60/607,047, filed on Sep. 3, 2004.

(51) Int. Cl. B05B 5/00

(52) U.S. Cl. 427/157; 427/258

(57) ABSTRACT

The present invention is directed to a method of offset lithographic printing text and images using invisible inks in order to provide differing visual characteristics when the text or image is observed under varying light conditions. That is, one image may be observed under normal, e.g., ambient, incandescent and fluorescent light conditions whereas another image may be observed only when the whole image is subjected to ultra-violet light such as a “black light.”

### BRIEF DESCRIPTION OF THE PRIOR ART

Various printing methods are well-known in the art and are adapted to a variety of general and specialized uses. Lithographic printing, for example, is well suited for both text and illustrations in short to medium length runs of up to 1,000,000 impressions. Typical products printed with offset printing processes include: general commercial printing, quick printing, newspapers, books, business forms, and financial and legal documents. Lithography is an “offset” printing technique. Ink is not applied directly from the printing plate (or cylinder) to the substrate as it is in gravure, flexography and letterpress. Ink is applied to the printing plate to form the “image” (such as text or artwork to be printed) and then transferred or offset to a rubber “blanket.” The image on the blanket is then transferred to the substrate (typically paper or paperboard) to produce the printed product.

On sheet-fed processes, the substrate is fed into the press one sheet at a time at a very high speed. Web-fed presses print on a continuous roll of substrate, or web, that is later cut to size. There are 3 types offset printing; non-heatset sheetfed, heatset, and non-heatset web offset. The difference between heatset and non-heatset is primarily dependent on the type of ink and how it is dried.

Offset printing is a widely used printing technique where the inked image is transferred (or “offset”) first to a rubber blanket, then to the printing surface. When used in combination with the lithographic process, which is based on the repulsion of oil and water, the offset technique helps avoid the transfer of water to the printing surface along with the ink.

The advantages of offset printing include: consistent high image quality—sharper and cleaner than letter press because the rubber blanket conforms to the texture of the printing surface; usability on a wide range of printing surfaces in addition to smooth paper (e.g., wood, cloth, metal, leather, rough paper); quick and easy production of printing plates; longer plate life than on direct lithographic presses, because there is no direct contact between the plate and the printing surface.

Lithography uses a planographic plate on which the image areas are neither raised nor indented (depressed) in relation to the non-image areas. Instead, the image and non-images areas, both on essentially the same plane of the printing plate, are defined by deferring physiochemical properties.

Lithography is based on the principle that oil and water do not mix (hydrophilic and hydrophobic process). Lithographic plates undergo chemical treatment that render the image area of the plate oleophilic (oil-loving) and therefore ink-receptive and the non-image area hydrophilic (water loving). During printing, fountain (dampening) solution which consists primarily of water with small quantities of isopropyl alcohol and other additive to lower surface tensions and control pH, is first applied in a thin layer to the printing plate and migrates to the oleophilic image areas. Since the ink an water essentially do not mix, the foundation solution prevents ink from migrating to the one non-image of the plate.

As the player cylinder rotate, the plate in contact with the dampening roller first. The dampening rollers wet to the plate so that the non-printing areas repeal ink. Then ink the inking rollers transfer ink to the dampened plate, where ink only adheres to the image areas. The linked image is transferred to the rubber blanket, and the substrates is printed as it passes between the blanket and impression cylinder.

There are three basic lithographic press; unit-design, common impression cylinder designed, and blanket-to-blanket design. The united-design press is a self-contained printing station consisting of a late cylinder, a blanket cylinder and a impression cylinder. Two or more stations may be joined to perform multi-printing. A common impression press consists of plate and blanket cylinders sharing a common impression cylinder. This allows two or more colors to be printed to a single station. A blanket-to-blanket press consists of two sets of plate and blanket cylinders without an impression cylinder. The paper is printed on both sides simultaneously as it passes between the two blanket cylinders.

The major unit operations in a lithographic printing operation include: image preparation, processing printing plates, printing, finishing, and image preparation of lithographic printing plates. Image preparation begins with camera-ready (mechanical) art/copy or electronically produced arts. Images are captured for printing by camera, scanner or computer. Components of the image are manually assembled and positioned in a printing flat when a camera is used. This process is called stripping. When art/copy is scanned or digitally captured the image is assembled b the computer with special software. A simple roof (brown print) is prepared to check for position and accuracy.

There are eight different types of lithographic plates common to the commercial printing industry: Diazo, Photopolymer, Silver Halide, Electrophotographic (Electrostatic), Bimetal, Waterless, Thermal, and Ablation. The predominant surface plate in use today is termed a “presensitized” plate. Most printers will primarily use one or two type of plates. Diazo plates are coated with organized compounds and are developed with a special solvent. They have a shelf life of about one year. These are used for print rungs of about 150,000 impressions. Photopolymer plates are coated with organized compounds and are very inert and abrasion resistant. This makes them last much longer than diazo plates. They are used for print runs of up to 250,000 impressions. Silver Halide plates use photosensitive coatings similar to photographic film, except that the silver halide emulsions are slower and for color production are coated on an anodized aluminum. The processing solutions contains silver which must be recovered with the proper equipment before being discharged to the sewer. Film based silver halide plates are used for single color printing and metal based silver halide plates are used in computer-to-plate systems.

Electrostatic plates are based on the principle of the electrostatic copier. There are two types, inorganic photoconductors on a drum and second is organic photoconductor on a substrate. These are used mostly in quick printing jobs of 100,000 impressions or less.

Bimetal plates use presensitized polymer coatings. There are two types of bimetal plates; copper plats on stainless steel or aluminum and chromium plates on copper. These are the most expensive, but rugged plates and are used for very long print runs. In fact they are capable of print runs in the millions. Waterless plates, used on waterless presses only, consist of ink on aluminum or the printing areas and a silicone rubber for the image areas. These systems require special links and high grade paper to avoid debris accumulating on the blanket. Ablation plates are imaged by digital data and requires no chemical process. These plates are digitally imaged by selectively burning tiny holes in thin coatings of polyester or metal base. These types of plates are used on the new computer to plate imaging systems and the brand new computer to press system. The cost of equipment materials is high and the technology is relatively new. Heat sensitive plates are exposed by infrared diodes in special imagesetter and processed in water based chemistry. This is a relatively new technology and requires the printer to invest in new equipment that can be quite costly.

There are four common types lithographic inks, unlike Gravure, Flexo and Screen printing inks, lithographic inks are very viscous to the point they are paste-like. Lithographic inks are generally very strong in color value to compensate for the lesser amount applied. Sheetfed lithographic inks are similar to oxidizing types of letter press inks. To accelerate drying and control ink flow characteristics lithographic inks contain solvents (or drying oils) which result in some VOC emissions of the ink. Linseed and grapeseed (canola) oil have been added to the lithographic links for years, but other vegetable oils like soybean oil and more frequently being used because of their lower VOC content, which helps eliminate smudging

Heat set inks are completely different from non-heatset inks and cannot be interchanged between the two types of presses. Heatset inks are quick drying inks for web printing. The solvents are vaporized as they pass through resins fixed to the paper in such a way that there is no chance for the ink to spread, smear, or soak into the paper. Heatset presses are equipped with a drier, and chilling system to cool the heated resins and the set the image. Heatset inks a significantly greater amount of VOC as compared to non-heatset lithographic inks. Therefore most heatset presets are also equipped with pollution control equipment such as a thermal oxidizer or after burner to destroy the high volumes of VOCs that are being emitted from these links.

Ultraviolet (UV) and Electron Beam (EB) curable links are also available for lithographic printing, but the press must be property equipped to run these types of inks. The use of UV curable inks is on the rise, particularly for the application of overprint coatings.

### SUMMARY OF THE INVENTION

The present invention is directed to a method of offset lithographic printing text and images using invisible inks in order to provide differing visual characteristics when the text or image is observed under varying light conditions. That is, one image may be observed under normal, e.g., ambient, incandescent and fluorescent light conditions whereas another image may be observed only when the whole image is subjected to ultra-violet light such as a “black light.”

### DETAILED DESCRIPTION OF THE INVENTION

In a preferred embodiment, involving lithographic offset printing, a first negative or transparency of an image is provided. The image may be a painting or drawing that has been photographed or scanned or some other image such as a photograph that may be scanned and developed into a negative. It is contemplated that a hand-drawn film in acetate may also be used to produce the negative. The first negative is then screened using conventional techniques by superimposing a conventional lithographic screen to form a first screen. The first screen is then used in a conventional lithographic engraving step to prepare a first printing plate which may then be used in a conventional offset lithographic printing process to produce a first image. In this embodiment, the first image is produced using normal inks that are visible in normal light.

A second negative or transparency of a second or complementary image is then provided. The image may also be a painting, drawing, or a writing that has been photographed or scanned or some other image such as a photograph that may be scanned and developed into a negative. It is contemplated that a hand-drawn film in acetate may also be used to produce the negative. The second negative is then screened using conventional techniques by superimposing a conventional lithographic screen to form a second screen. The second screen is then used in a conventional lithographic engraving step to prepare a second printing plate which may then be used in a conventional offset lithographic printing process to produce a second image. In this embodiment, the second image is produced using invisible inks that are visible only under ultra-violet normal light. Preferred inks include water-based invisible fluorescent inks that may also be UV curable. Moreover, the second image is printed directly over the first image on the same substrate such that a “double-image” is produced. In this double image, the first image is visible under normal light and the second image is visible under ultra-violet light. Preferred substrates include paper, canvas, glass, ceramics, metal, plastic, wood, and clothing. The second image may preferably be cured with a 200 watt per inch UV lamp on a belt at 100 feet per minute. In order to prevent bleeding of the first image into the second image or vice versa, it may also be desirable to apply at least one layer of varnish to the second image. A third varnish layer utilizing a spray varnish may also be used to provide a permanent protective gloss coating to the images. A particularly preferred varnish includes Krylon® Crystal Clear Acrylic Coating.

In the embodiment above, a third image using a different color ink or invisible ink may also be produced using the same process as that used for the first and second images. The third image is then printed over the first and second images. One or more third images may be produced in order to achieve the desired final image. Finally, the first negative and the second negative can be combined to create a third negative or transparency that contains both the first and second images. The third negative can be used as a guide for production of the final image such that the user may see the final image using the third negative and may make adjustments to the first and second negatives as desired without having to print the images onto a substrate thereby avoiding costly errors or corrections.

In a second preferred embodiment, the process described above is used in connection with printed text such as that used in books, book covers, greeting cards, post cards, stationary, periodicals and the like, such that certain text is visible under normal light and other text is visible only under ultra-violet light. This embodiment would be particularly desirable in the context of a book where the reader must use a black light to find “hidden” text or pictures within the text of a book. In this embodiment, the full text of a book is produced using normal offset lithographic printing processes and normal inks. This text is visible under normal light. The text that is intended to be invisible is then marked in blue and negatives or transparencies of the blue text are then produced. The book is then re-printed so that the normal text remains visible under normal light using normal inks and the blue text is printed in invisible inks so as to be visible only under black light. A layer of spray varnish may also be applied.

In a third preferred embodiment, a conventional silk screening method is employed to produce the first image and the second image and, more preferably, one or more third images, onto an article of clothing or other fabric such as silk, cotton, rayon, cashmere, pashmina, or any suitable fabric or material. In this method, a first screen is provided having a first image thereon that is then silk screened onto the desired fabric using normal inks suitable for use on textiles. A second screen is also provided having a second image thereon that is then silk screen onto the same fabric using invisible inks suitable for use on textiles. A final image is thereby produced on the fabric so that a first image is visible under normal light and a second image is visible under ultra-violet light.

In a fourth preferred embodiment, images or text may be produced using conventional color printers such as an inkjet or laser printer. Creating inexpensive limited edition color proofs of books and other printed materials can be a challenge when it is desirable to show the effects of specialty inks such as invisible inks. Traditional color printers are designed to simulate visible light colors only. The method of the present invention involves the following steps: (1) print the colored sheets, approximately 20-30 sheets, on both sides as 4-page signatures; (2) first print page 4 on the left and page 1 on the right of the sheets in color on an inkjet or color laser printer; (3) flip the sheets left-to-right and then print pages 2 and 3 on the same printer. To print more than one page on a sheet, choose the “print” feature of the word processing program being used. Click under “Print” and “Copies and Pages” from “2 to 3” pages. Select the “Layout” Feature and then choose “2” pages per sheet. Click “Print” and print a page with page 2 on the left and page 3 on the right. Flip the printed sheet left-to-right. Click “Print” and “Copies and Pages” from “4 to 4” pages. Select “Layout” and choose “2” pages per sheet. Click “Print” and a page with page 4 on the left will print. Load the same sheet into the printer again, with the one-half blank sheet on the left. Choose “Print” and “Copies and Pages” from “1 to 1” pages. Select “Layout” and choose “2” pages per sheet. It is important to reverse the order so that when the page prints it now prints on the left side of the paper. Click “Print” and a page with page 1 on the left will print. According to this method, a four-page color spread of four pages of a book or other periodical is printed.

Any of a variety of methods may be adapted according to the teachings of the present invention. In addition to offset lithographic techniques, silkscreen printing, and printing using computer-controlled printing devices (such as, for example, inkjet or laser printers), the present method may be adapted to hand printing techniques (including painting, drawing, and the like), serigraph, stenciling techniques, or other lithographic techniques. Any suitable method of printing known in the art may be adapted according to the teachings of the present invention.

In addition, a variety of “invisible” inks, paints, or other media may be used in the present invention, including UV latex, UV acrylic, UV oils and inks, and the like. In addition to media that is invisible under normal lighting conditions, thermochromatic media may be employed such that a previously invisible text or image becomes visible as a result of changes in the local or ambient temperature.

For example, in another embodiment of the present invention, a candle is provided in a candleholder that is preferably constructed from a material that is capable of conducting heat. For example, the candle may be provided in a crystal candleholder. The candleholder includes a label affixed to the outside thereof, the label having an image or message printed thereon. In addition, an alternative image or message is provided in thermographic media (such as ink) that is invisible to the eye under normal temperature conditions. Once the candle is lit, however, the candleholder heats up and the thermographic media is revealed, thereby also revealing the previously-hidden alternative text or image. Once the heat source is removed and the level of heat immediately surrounding the label drops below a threshold, the original image or text returns. Rather than use an image applied to a label and affixed to the candleholder, the thermographic media (and traditional, visible media) my be applied directly to the surface of the candleholder in order to achieve the desired effect.

In another embodiment of the present invention, a prayer card is provided, the card having a prayer inscribed thereon in ink or other media. The prayer card further includes an image or additional text in thermographic media, either on the same side of the card as the prayer or on the other side thereof. When the card is held between the hands, such as during viewing of the card, the thermographic image or text is revealed. This aspect of the present invention may likewise be applied to the printing of any cards, books, postcards, and the like, as may the UV-visible media techniques described above.

In another embodiment of the present invention, invisible inks or dyes are applied to threads or other material prior to the manufacture of an article of clothing or other item. For example, threads having invisible or UV-visible dyes applied thereto may be incorporated into the manufacture of a pair of jeans. The thread having the invisible dye thereon may be incorporated into the jeans in a design or pattern that becomes visible under UV light or the proper temperature conditions. Jeans or other items of this type may be augmented with semi-precious stones such as amber, amethyst, and the like.

The principles of the present invention may be applied to online use as well. For example, a web site may be provided having invisible text that is revealed only when a user's mouse cursor passes over the portion of the site having the hidden text or images. Such effects may be accomplished using Flash software, Javascript, or any other suitable programming language or method of selectively hiding and presenting text or images on a web site.

It will be readily apparent to one of skill in the art upon reading this disclosure that the method disclosed herein may be applied to a number of products and application. For example, the present method may be used with respect to toys, watches, jewelry, clothing and other textiles, regardless of material, paper products, board or wood products, metal products, ceramics, porcelain, glass, pottery, sculptures of all materials, plates, games, plastics and other synthetic compounds, bed and bath products, accessories, and the like. The present method may likewise be applied regardless of the underlying material upon which the invisible media is being printed. Likewise, the invisible image or text may be produced in conjunction with a visible image or text, or entirely on its own, with no corresponding visible counterpart. Too, any suitable method of applying an image to a surface may be utilized, including hand-retouch methods.

The examples and disclosure above is provided by way of example only and does not limit the scope of the present invention, which is limited only by the claims below.

1. A method of providing invisible text or images on an object comprising the steps of:
a) providing an object to be printed upon;
b) applying to at least a portion of said object a pigment not visible under a first set of conditions of use of said object;
wherein said pigment is capable of becoming visible under a second set of conditions of use of said object.

2. The method of claim 1 wherein said second set of conditions include UV light, heat, cold, and combinations thereof.

3. The method of claim 1 wherein said object is selected from the group consisting of an article of clothing, a card, and a book.

4. The method of claim 1 wherein said object is comprised of silk, denim, cotton, rayon, cashmere, pashmina, and polyester.

5. The method of claim 1 wherein said pigment is applied by a process selected from the group consisting of silkscreen, lithograph, offset lithograph, serigraph, stenciling, hand application, inkjet printing, laser printing, and combinations thereof.

6. The method of claim 1 wherein said pigment is selected from the group consisting of inks, oil paints, acrylic paints, latex, and combinations thereof.

7. A method of providing invisible text or images on a web site comprising the steps of:
a) providing a web site having a hidden portion not visible to a user upon said user's initial access of said web site; and
b) revealing said hidden portion to said user when said user positions a mouse cursor over said hidden portion.
